(19) United States
(12) Patent Application Publication
(10) Pub. No.: US 2002/0141193 A1
(43) Pub. Date: Oct. 3, 2002

(54) Light reflector

(76) Inventor: Kwan Yew Chong, Kuala Lumpur (MY)

Correspondence Address: JACOBSON HOLMAN PLLC, 400 SEVENTH STREET N.W., SUITE 600, WASHINGTON, DC, 20004, US

(21) Appl. No.: 09/964,355

(22) Filed: Sep. 28, 2001

(30) Foreign Application Priority Data
Mar. 30, 2001 (MY) PI 20011523

(51) Int. Cl. F21V 7/00

(52) U.S. Cl. 362/308; 362/296; 362/307; 362/341; 362/343; 362/350; 362/329

(57) ABSTRACT

A light reflector (10) comprises a plastics reflector bowl (11) having an inner surface (21), an outer surface (23), a narrow aperture (14) and a wide lower diffuser lens (24). Mounting means (12) is provided at the narrow aperture for mounting the reflector on to a housing for control gear of a light source. The narrow aperture is adapted to house the light source. The reflector bowl (11) and mounting means (12) are formed as a single reflector unit by plastics moulding with at least one of the inner or outer surfaces being surface-metalized to a reflective finish. There is also provided an open version of the light reflector and a method of forming a light reflector.

### TECHNICAL FIELD

The present invention relates to an enclosed version and open version of a light reflector, particularly for use in highbay and lowbay applications. The invention also relates to a method of manufacturing the reflector.

### BACKGROUND OF THE INVENTION

Highbay and lowbay light reflectors are popularly made of anodised aluminium, moulded ribbed prismatic plastics or glass. The main function of highbay and lowbay reflectors is to distribute lamp light downwardly in highbay and lowbay industrial and commercial applications. Anodised aluminium has limited luminous output efficiency as does prismatic plastics or glass. Prismatic plastics or glass additionally suffer from luminous loss through light diffusion. More significantly, the enclosed or ingress protected (IP-rated) versions of current reflector systems are composed of a multiple of components, such as separate clear diffuser cover lens, gasket and clamp band for lens attachment. Products based on multiple components invariably require additional moulds and dies, additional production and assembly processes and more space for storage.

### SUMMARY OF INVENTION

The present invention aims to produce a simplified one-piece enclosed version and open version of a light reflector suitable for highbay and lowbay applications and having improved light output efficiency.

According to the present invention there is provided a light reflector comprising: a plastics reflector bowl having an inner surface, an outer surface, a narrow upper aperture and a wide lower end which lower end is a clear diffuser lens so as to form an enclosed version of the light reflector; mounting means at the upper aperture for mounting the reflector onto a housing for control gear of a light source, wherein the upper aperture is adapted to house the light source; characterised in that the reflector bowl, mounting means and diffuser lens are formed as a single light reflector unit by plastics moulding, and that at least one of the inner or outer surfaces is surface-metalised to a reflective finish.

According to the present invention there is further provided a light reflector comprising: a plastics reflector bowl having an inner surface, an outer surface, a narrow upper aperture and a wide lower end which is an aperture; and mounting means at the upper aperture for mounting the reflector onto a housing for control gear of a light source, wherein the upper aperture is adapted to house the light source; characterised in that the reflector bowl and mounting means are formed as a single unit by plastics moulding, and that at least one of the inner or outer surfaces is surface-metalised to a reflective finish.

According to the present invention there is still further provided a method of manufacturing a light reflector characterised by plastics moulding a reflector bowl having an inner surface, an outer surface, a narrow upper aperture, a wide lower end and a mounting means at the upper aperture for mounting the reflector onto a housing for control gear of a light source, wherein the upper aperture is adapted to house a light source; priming the inner surface or outer surface for surface-metalising; vacuum surface-metalising said inner or outer surface to a reflective finish.

### BRIEF DESCRIPTION OF THE DRAWINGS

The present invention is described further by way of example with reference to the accompanying drawings by which:

FIG. 1 is an upper perspective view of an enclosed version of a light reflector according to one of the embodiments of the invention;

FIG. 2 is a side view of a first version of the enclosed version of a light reflector;

FIG. 3 is a side view of a second version of the enclosed version of a light reflector;

FIG. 4 is an upper perspective view of an open version of a light reflector according to a second embodiment of the invention; and

FIG. 5 is a side view of the reflector of FIG. 4.

### DETAILED DESCRIPTION OF PREFERRED EMBODIMENT OF INVENTION

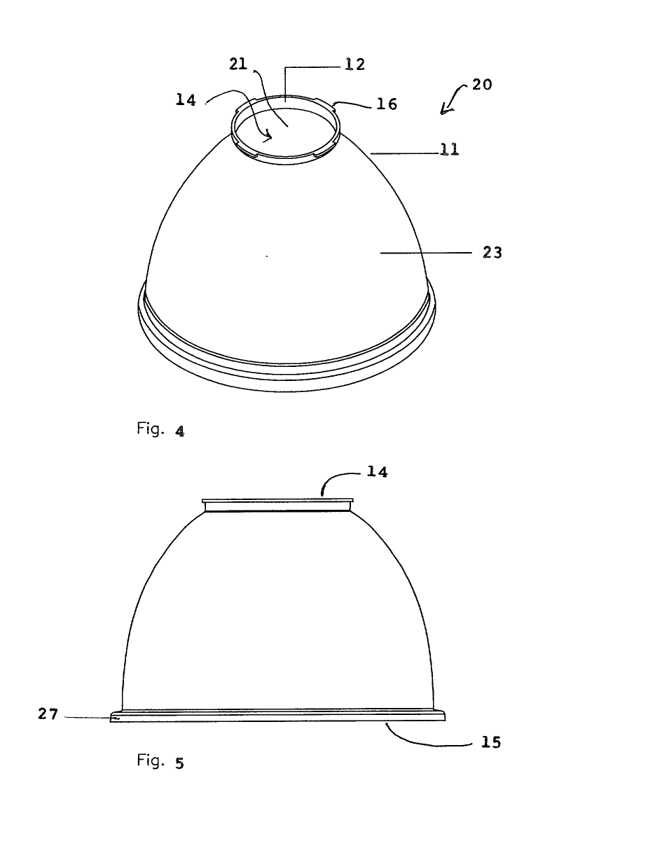

A simplified one-piece enclosed or IP-rated version of light reflector 10 as illustrated in FIGS. 1 to 3 is produced by blow moulding of preformed injection moulded clear plastics, followed by surface-metalising the inner or outer wall surface of the reflector. A one-piece open version of the light reflector 20 is illustrated in FIGS. 4 and 5 and is produced by blow moulding or injection moulding with at least one of its inner or outer surfaces finished with a metallic layer.

The embodiments of the light reflector 10, 20 comprise a clear plastics reflector bowl 11, preferably parabolic in shape, and having an upper narrow aperture 14 and a lower wide end 15, 15′. A mounting means 12 is provided at the narrow aperture 14 to mount the reflector onto control gear housing for a light source (not shown). The reflector 10, 20 is adapted to house a light source, such as a bulb, through narrow aperture 14 with reflector bowl 11 surrounding the light source in use.

Mounting means 12 comprises a rim at the narrow aperture projecting outwardly of the reflector bowl 11 and having a twist-and-lock thread 16 including tabs projecting normally to the rim. The mounting means 12 allows the light reflector to be mounted on the housing of the light source control gear by twisting and locking into a mating thread. The mating thread on the control gear housing which receives the mounting means may be formed from moulded plastics or die-cast aluminium and is integrally formed with the housing.

The reflector bowl 11 has an inner surface 21 and an outer surface 23, with one or both surfaces, being surface-metalised to a specular finish to enhance the light output efficiency of the reflector. In the present embodiments of the light reflector, a layer of pure aluminium is used to coat the surface. Surface-metalising involves firstly coating the surface with a primer and then applying a layer of pure aluminium using a known vacuum-metalising technique. The result is a highly reflective surface that increases the light output compared with known light reflectors.

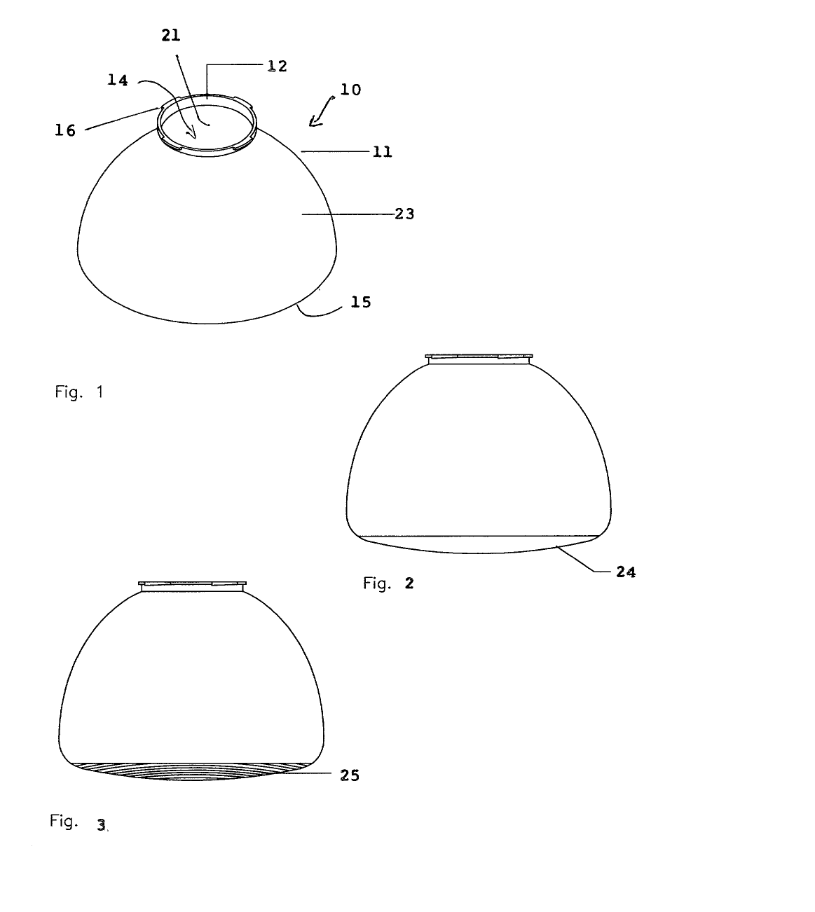

FIG. 2 illustrates an IP-rated or enclosed embodiment of the reflector having a diffuser lens 24 integrally moulded as the wide end 15 of the reflector bowl 11. Diffuser lens 24 is made of clear plastics to allow light to diffuse through whilst protecting the interior of the reflector, and light source, from moisture, dust and other particles. In FIG. 2 the diffuser lens is illustrated plain to serve as a light diffuser. In FIG. 3 the light diffuser lens 25 is moulded in a pattern of concentric circles or other patterns to produce a prismatic effect of the diffuse light.

An open version of the light reflector 20 is illustrated in FIGS. 4 and 5. In this embodiment there is no diffuser lens 24 or 25 and wide end 15′ is left open. This open version can be formed by either cutting off the diffuser lens of an enclosed version of the reflector thus creating an aperture or by separately injection moulding the open reflector in clear plastics. FIGS. 4 and 5 illustrate a specifically moulded open reflector. A small flange 27 is provided at the circumference of the wide aperture 15′ to provide a finished look to the reflector.

All components of both the enclosed and open versions of the light reflector are moulded in a single plastics unit using a single plastics moulding process. The reflector is formed by blow moulding or injection moulding a suitable plastics, such as clear polycarbonate or acrylic. For the IP-rated version the diffuser lens is moulded in the same moulding process as the reflector bowl and mounting means. The diffuser lens can then be cut away to form an open version reflector. The plastics reflector moulding is surface-metalised on the inner and/or outer surface to produce a reflector with a highly reflective finish. Since the reflector is made of clear plastics, surface metalising either the inner or outer surface will have the same effect. A colourful or decorative layer of metal may be applied to the outer surface of the reflector for decorative and aesthetically pleasing purposes.

Surface metalising the inner surface of an enclosed version of a reflector involves entering the inside of the reflector through upper aperture 14 and pre-treating the inner surface 21 with a primer. Metal vapour is next introduced in the reflector under a vacuum and adheres to the primed surface. The metal vapour avoids adhering to the diffuser lens because the lens is not primed.

Improved light output efficiency is achieved with the present metalised moulded plastics reflector. Using pure aluminium as the specular finished metalised layer enhances the reflector's luminous output efficiency to 95%, compared with about 84%-87% for anodised aluminium. These values are calculated using photometric data. The light reflector is suitable for outdoor and indoor lighting applications. It has a simplified design and is formed as a single unit, obviating the need for gaskets, clamps and other components. The reduced number of components, compared with known reflectors, reduces manufacturing costs owing to the fewer moulds and dies required and the reduced steps in manufacturing.

It will be understood to persons skilled in the art of the invention that many modifications may be made without departing from the scope of the invention.

The claims defining the invention are as follows:

1. A light reflector (10,20) comprising:
a plastics reflector bowl (11) having an inner surface (21), an outer surface (23), a narrow upper aperture (14) and a wide lower end (15, 15′); and
mounting means (12) at the upper aperture (14) for mounting the reflector onto a housing for control gear of a light source, wherein the upper aperture is adapted to house the light source;
characterised in that the reflector bowl (11) and mounting means (12) are formed as a single light reflector unit by plastics moulding, and that at least one of the inner or outer surfaces is surface-metalised to a reflective finish.

2. The reflector according to claim 1 characterised in that the reflector bowl is made of clear plastics.

3. The reflector according to claim 1 or 2 characterised in that the wide end (15) is a clear diffuser lens (24) to form an enclosed version of the light reflector.

4. The light reflector according to any one of the preceding claims characterised in that both the inner and outer surfaces of the reflector bowl are surface-metalised.

5. The light reflector according to any one of the preceding claims characterised in that the reflector bowl is surface metalised with aluminium.

6. The light reflector according to any one of the preceding claims characterised in that the light reflector unit is formed by blow moulding or injection moulding.

7. The light reflector according to any one of the preceding claims characterised in that the mounting means (12) is a twist and lock thread (16) projecting from the upper aperture (14).

8. The light reflector according to any one of the preceding claims wherein the reflector bowl is parabolic in shape.

9. The light reflector according to claim 3 wherein the diffuser lens has a plain design (24).

10. The light reflector according to claim 3 wherein the diffuser lens has a prismatic design (25).

11. The light reflector according to any one of the preceding claims wherein the outer surface of the reflector is surface metalised in a colourful or decorative manner.

12. The light reflector according to claim 1 wherein the wide lower end (15′) is an aperture.

13. A light reflector (10) comprising:
a plastics reflector bowl (11) having an inner surface (21), an outer surface (23), a narrow upper aperture (14) and a clear diffuser lens (24) at a wide end (15) so as to form an enclosed version of a light reflector; and
mounting means (12) at the upper aperture for mounting the reflector onto a housing for control gear of a light source, wherein the upper aperture is adapted to receive the light source;
characterised in that the reflector bowl (11), mounting means (12) and diffuser lens (24) are formed as a single light reflector unit by plastics moulding, and that at least one of the inner or outer surfaces is surface-metalised to a reflective finish.

14. A method of manufacturing a light reflector (10,20) characterised by plastics moulding a reflector bowl (11) having an inner surface (21), an outer surface (23), a narrow upper aperture (14), a wide lower end (15, 15′) and a mounting means (12) at the upper aperture for mounting the reflector onto a housing for control gear of a light source, wherein the upper aperture is adapted to house a light source;
priming the inner surface (21) or outer surface (23) for surface-metalising;
vacuum surface-metalising said inner or outer surface to a reflective finish.

15. The method according to claim 14 characterised by using clear plastics in the plastics moulding.

16. The method according to claim 14 or claim 15 characterised by moulding as a single unit a plastics diffuser lens (24) at the lower end of the reflector bowl to form an enclosed version of the light reflector.

17. The method according to claim 16 characterised by accessing an inside of the reflector bowl through the upper aperture to prime and surface-metallise the inner surface of the bowl.

18. The method according to any one of claim 16 or 17 characterised by moulding the diffuser lens with a prismatic design.

19. The method according to any one of claims 14 to 18 characterised by surface metalising the outer surface of the reflector in a colourful or decorative manner.
